(19) United States
(12) Patent Application Publication
(10) Pub. No.: US 2014/0128039 A1
(43) Pub. Date: May 8, 2014

(54) System and Method for Storing and Managing Voicemails

(71) Applicant: Veem, Inc., Santa Monica, CA (US)

(72) Inventor: David Maybach, Santa Monica, CA (US)

(73) Assignee: Veem, Inc., Santa Monica, CA (US)

(21) Appl. No.: 14/073,851

(22) Filed: Nov. 6, 2013

Related U.S. Application Data
(60) Provisional application No. 61/722,866, filed on Nov. 6, 2012.

(51) Int. Cl. H04M 3/533; H04M 3/493; H04W 4/12

(52) U.S. Cl. CPC H04M 3/53333; H04W 4/12; H04M 3/493
USPC 455/413

(57) ABSTRACT

One embodiment of a method of retrieving voicemail messages that were previously recorded for a user on a carrier voicemail system in a communication network includes storing user data related to voicemail retrieval for the user, storing carrier data related to voicemail retrieval from the carrier, connecting to the carrier voicemail system through the communication network, receiving audio signals through the communication network from an interactive voice response system of the carrier voicemail system, sending audio signals through the communication network to the carrier voicemail system to navigate the interactive voice response system based on predetermined response conditions, recording audio signals received from the voicemail system according to predetermined playback criteria and disconnecting from the voicemail system.

### BACKGROUND OF THE INVENTION

In both business and personal spaces, individuals are increasingly relying on contact through their portable telephones. Electronic mail, SMS/MMS messages, and PDA applications are used to exchange immediate information between users at terminals across the world. Communication through voicemails, however, can be both time- and labor-intensive.

In a typical cellular telephone “basic voicemail” system, a user must use their device to call an access number assigned by the user's cellular telephone carrier. Then, the user must listen to a series of prompts, such as, for example, “You have a new message. To listen to your message, press 1. For other options, press 2.” The user must then input through speech or by manually activating the interface on the device their desired action. They must also frequently listen to multiple voicemail messages before they can listen to a desired message. This can cause delay and frustration, particularly when compared with the speed and ease of other modes of communication.

Storage of voicemails on a carrier's system is frequently limited in time and length of message. In order to save storage space, carriers typically delete voicemails that are older than a certain threshold. This can leave users without important information that was included in older voicemails.

Some systems have been devised to allow more practical storage and access to voicemails. For example, U.S. Pat. Pub. No. 2010/01059889 discloses a method of temporarily assigning a unique telephone number to each voicemail, so that a user may have a way to access the specific voicemail on a call. This method eliminates some of the time it would take to find a specific voicemail, but still requires a user to spend the time to call in, listen to prompts, etc., and is based on the assumption that the voicemail will be deleted to free up the unique telephone number for assignment to another voicemail.

Other systems attempt to bypass the cellular telephone voicemail system entirely, forwarding incoming calls to a separate server or to the user's device itself. This “visual voicemail” system may aid in the access and storage of the voicemails by allowing headers of each voicemail to be views, such as date, time, and sender. An example of such a system is shown in, for example, U.S. Pat. No. 7,996,792. However, a user must still search through unorganized, non-indexed voicemails and listen to various potential voicemails to find a desired voicemail, making long-term storage unlikely and unmanageable. Further, a user may lose the voicemails saved on the device when, for example, the mobile phone was stolen, damaged, lost, or when upgrading mobile phones, and the voicemails previously stored in the carrier's voicemail system would still be inaccessible through visual voicemail. Such visual voicemail systems can display voice message the device received during its life time. A new device would not display the voicemails from the previous device or the voicemails resident on the carrier's voicemail system.

A need therefore exists for a more time- and labor-efficient way for accessing, storing, and managing voicemail messages.

### SUMMARY OF THE INVENTION

Various embodiments of the invention describe a method of retrieving voicemail messages from any carrier in a communication network. In one embodiment, the method includes receiving a request to retrieve voicemail data from a carrier voicemail system, connecting to the carrier voicemail system through the communication network, receiving signals from an interactive voice response system of the carrier voicemail system, sending signals to the carrier voicemail system to interact with the interactive voice response system based on response criteria, upon detection of a playback criteria, recording audio received from the carrier voicemail system, saving the recorded audio, and disconnecting from the carrier voicemail system.

The foregoing aspects and other forms, features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is an architectural diagram showing one example of a prior art voicemail system.

FIG. 2 is an architectural diagram showing an embodiment of a system according to the invention.

FIG. 3 is a simplified block diagram of one embodiment of a voicemail server of FIG. 2 according to the invention.

FIG. 4 is an architectural diagram showing another embodiment of a system according to the invention.

FIG. 5 is process flow diagram according to one embodiment of a method according to the invention.

FIG. 6 is a process flow diagram according to another embodiment of a method according to the invention.

FIG. 7 is a process flow diagram according to yet another embodiment of a method according to the invention.

FIG. 8 is a simplified flow diagram of a voicemail sharing and managing system and method according to the invention.

FIG. 9 depicts a display of the web site/humor blog according to one embodiment of the invention.

FIG. 10 depicts a search interface according to one embodiment of the invention.

FIG. 11 depicts another search interface according to the embodiment shown in FIG. 10.

FIG. 12 depicts a display of another embodiment of an interface according to the invention.

### DETAILED DESCRIPTION OF THE INVENTION

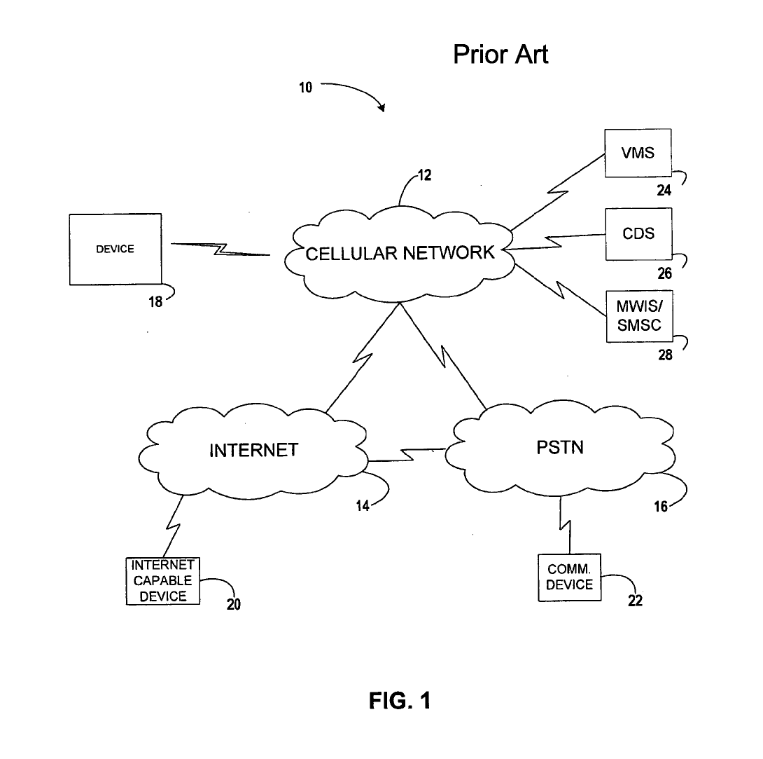

FIG. 1 is an architectural diagram showing one embodiment of a traditional voicemail system, as shown in U.S. Pat. Pub. No. 2010/01059889. As described, a communications network 10 includes a cellular network 12, the Internet 14, and a public switch telephone network (PSTN) 16. The cellular network 12 can include various base transceiver stations, base station controllers, mobile switching centers, short message service centers, multimedia messaging service centers, home location registers, charging platforms, traditional voicemail platforms, visual voicemail platforms, GPRS core network components, etc. Although the cellular network 12 is shown in communication with the Internet 14 and PSTN 16, alternate configurations are possible.

Mobile device 18, such as a cellular telephone, laptop, PDA, tablet, etc., with a transceiver can be linked to the cellular network 12, PSTN 16, and/or the Internet 14. Internet-capable device 20, such as a computer, Internet-enabled telephone, etc., can be linked to the cellular network 12 through the Internet 14, PSTN 16 and/or the cellular network 12. Communication device 22, such as a telephone, facsimile machine, modem, etc., can likewise connect to the PSTN 16, and then to the Internet 14 and/or the cellular network 12.

The communications network 10 includes a voicemail system (VMS) 24, a content delivery server (CDS) 26 for delivering messages and message content to mobile device 18. A message waiting icon server (MWIS) 28 sends short messages to mobile devices that a new message is waiting. VMS 24, CDS 26, and MWIS 28 can be hardware, software, or a combination of both, and they may be connected to the cellular network 12 as shown, or residing in hardware, software, or both in one or more of the cellular network 12, PSTN 16, mobile device 18 the Internet 14, etc.

In operation, the system according to FIG. 1 can receive and record a voicemail left by an incoming caller and store the voicemail in the VMS 24. The voicemail may be stored, for example, as an audio file, a text string based on a speech-to-text process, etc. The VMS 24 may also create a header file, which includes data generated or received from the call, such as, for example, time and date of call, caller ID of the incoming caller, number that was called indicating an intended recipient, information designating the call as “urgent”, etc.

In systems employing MWIS 28, a signal can be sent from the VMS 24 to the MWIS 28 to indicate that a new voicemail has been stored, and the MWIS 28 can send an alert to mobile device 18 via the cellular network that a new message has been received. The mobile device 18 can then dial a voicemail access number to access the VMS 24 to listen to their messages and interact with various voicemail applications (VMAs), such as, for example, interactive voice response (IVR) applications.

Alternatively, a mobile device 18 can send a request signal through the cellular network 12 to CDS 26 for retrieval of header information and/or audio file constituting the voicemail message if the message is given a unique access number, as discussed in the Background. The CDS 26 can then send the header information corresponding to the unique access number to the mobile device 18 for storage thereon. The mobile device 18 user may then call the unique access number to listen to the particular voicemail message.

This process may also be used by internet-connected device 20 that may access the VMS 24 via the Internet 14, or by communications device 22 that may access the VMS 24 via PSTN 16. Each of devices 18, 20, 22 are terminals that may include customary components, for example, interfaces, displays, microphones for recording sounds, speakers for playing sounds, etc. As these components of terminals 18, 20, 22 are well-known in the art, further description is deemed unnecessary for this disclosure.

As discussed in the Background, this method for retrieving voicemail messages from the VMS 24 can be time- and labor-consuming, as well as unmanageable for longtime voicemail storage. Each time a voicemail is retrieved, the user must make a call to the access line, listen to and respond to the IVR prompts, navigate through possibly multiple audible messages with minimal introductory information to let the user know if the message is of interest. Storage of memorable voicemails, for example, would traditionally be archived only under date, time, and possibly caller ID, which would need to be audibly communicated to the user before knowing whether the particular voicemail is the one desired.

Even when each particular voicemail is accessed via a unique access number, as discussed above, storage, navigation, and management is dependent on little header information and limited storage on the cellular network.

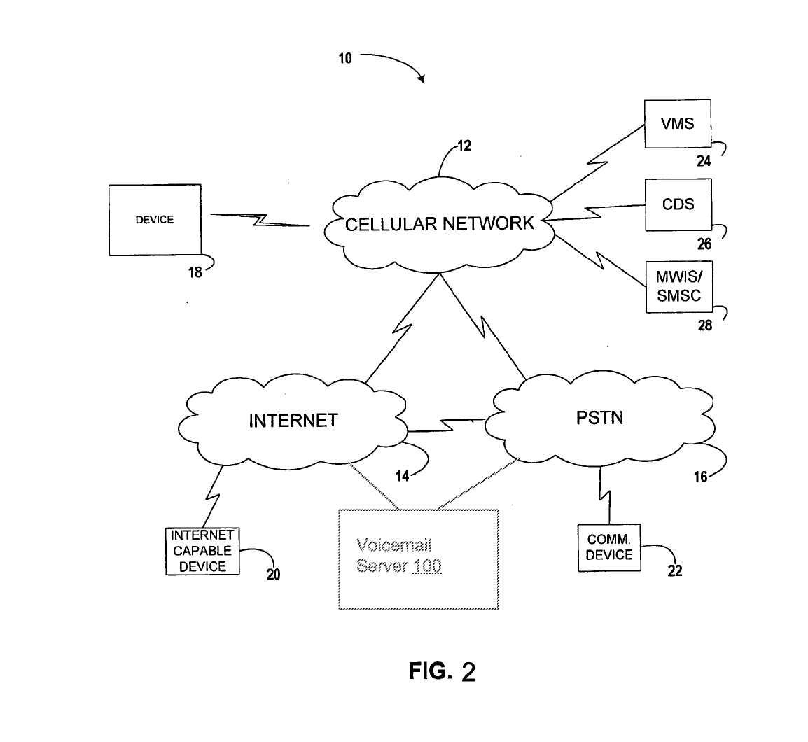

FIG. 2 is an architecture diagram according to one embodiment of the invention. Communications network 10 is as described above. In addition to the traditional system, however, the current embodiment includes voicemail server 100 connected to the Internet 14 and in communication with the VMS 24 through cellular network 12 as shown. Although the voicemail server 100 is shown as communicating with the VMS 24 via PTSN 16 and cellular network 12, it is also within the scope of the invention for the voicemail server 100 to connect to the VMS 24 directly, via the cellular network 12 or via the Internet 14. Although voicemail server 100 is shown as a single server connected to both PSTN 16 and the Internet 14, it is also within the scope for the components or functions of the voicemail server as described in more detail below to be resident in separate, locations connected by a network. In such cases, some separate components may connect to only PSTN 16, only the Internet 14, or neither of those. In one embodiment, for example, the functions and components of voicemail server 100 are performed and located on a mobile device 18.

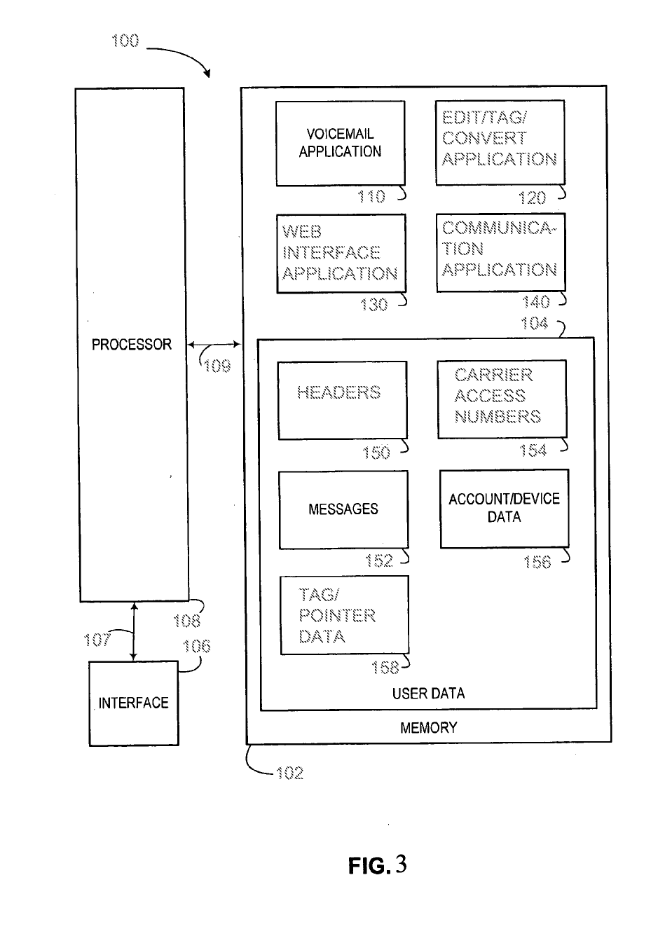

FIG. 3 is a simplified box diagram of voicemail server 100. In this embodiment, voicemail server 100 includes a memory 102, user data 104, a communication interface 106, and a processor 108. Communication interface 106 can allow the voicemail server 100 to communicate with other devices and servers in communications network 10 and can be, for example, an antenna, transceiver, transmitter, receiver, connection port, microphone, etc., or any combination thereof. Communication interface 106 is coupled via a data/memory bus 107 to processor 108. Likewise, processor 108 is coupled via data/memory bus 109 to memory 102, although it is also within the scope of the invention for the processor 108 to be, for example, located remotely and coupled via other means, such as, for example, via Internet 14.

Memory 102 includes user data 104, voicemail application 110, edit/tag/convert application 120, web interface application 130, and communication module 140.

User data 104 includes headers 150, messages 152, carrier access numbers 154, account/device data 156, and tag/pointer data 158.

Voicemail application 110 includes instructions, programs, applications, software, or the like for receiving, processing, and storing voicemail messages. In one embodiment, voicemail application 110 includes instructions for recording signals received from the interface 106. Voicemail application 110 may also include, for example, instructions for processing the recorded signals to determine tones, silence, words, etc. and to interact with edit/tag/convert application 120, communication application 140, and web interface application 130, as discussed later. Voicemail application 110 may also include instructions regarding storage of headers 150, such as date, time, and caller ID information, carrier access numbers 154, such as the phone numbers or web address information for accessing a carrier's voicemail storage system 24, files representing the actual voicemails received 152, account/device data 156 including a subscriber/user's account number, name, phone number, birthday, passwords, list of relatives, social network usernames and passwords, etc., as well as tag/pointer data 158 for additional information about a particular voicemail, such as subscriber/user entered keywords, whether the voicemail is important, whether the voicemail was sent from a family member, whether the voicemail was sent on the subscriber/user's birthday, etc.

Web interface application 130 includes instructions, programs, applications, software or the like for sending and receiving signals from a terminal/device 18, 20, 22 operated by a voicemail subscriber to access, display, and play back user data 104 through a standard device interface, such as a display, speaker, or the like. Web interface application 130 may also interact with voicemail application 110 and/or edit/tag/convert application 120 to allow a subscriber to edit or convert user data 104, add key terms, hashtags, descriptors, file/directory structures or pointers to voicemails stored in user data 104 and/or to export user data 104 to, for example, a social network server, another user device or devices 18, 20, 22, etc. Web interface application 130 may also interact with voicemail application 110 and communications application 140 to request new voicemails be retrieved from the carrier VMS 24.

Communication application 140 includes instructions, programs, applications, software or the like for sending and receiving signals via the interface 106 from/to the carrier's VMS 24. The communication application 140 can, for example, instruct the interface 106 to call a carrier access number 154, wait until either a specified period of time or until a particular signal is received, provide signals in response to prompts from the carrier's WR, interact with voicemail application 110 to record and process the voice messages.

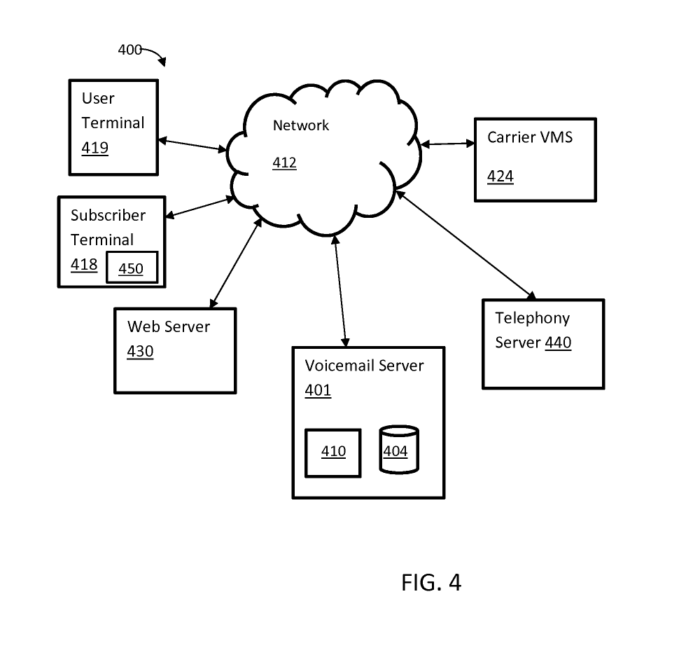

Although each of the modules, applications, and databases 104, 110, 120, 130, and 140 are shown as existing in the same memory 102, one skilled in the art will readily understand that one or more of these modules/applications/databases may be located in a separate memory location that is coupled, either directly or via a network, to memory 102 and voicemail server 100 using the same or different processors 108. One embodiment of such a system is depicted in FIG. 4. It is also within the scope of the invention for one or more of the functions of the various modules/applications/databases to be instructed by the same application, software, or module and performed by the same or different processors 108.

As shown in FIG. 4, the system 400 includes voicemail server 401 with user database 404 and voicemail application 410, substantially as described above in connection with FIG. 3. In this embodiment, the communication module 140 is on a separate telephony server 440 connected to voicemail server 401 via network 412. The telephony server may be, for example, a multi-protocol soft switch/PBX, such as FreeSWITCH™ or Asterisk™. Network 412 can be any wired or wireless communication coupling such as, for example, the Internet, local area network, personal area network, connection via communication cable, PSTN, etc., including networked combinations thereof. Although only one such network 412 is shown in FIG. 4, one skilled in the art will recognize that the various elements connected via network 412 may alternatively be connected by separate individual networks 412.

System 400 also includes web server 430, the functionality of which corresponds to web interface application 130 of FIG. 3, but resides separately from voicemail server 401 in this embodiment. Web server 430 may be a separate server or may be, for example a native application 450 running on a terminal, such as device 418. As described above, native application 450 may alternatively perform functions of the voicemail server 401, telephony server 440, and/or any combination. Subscriber terminal 418 can be any connected device operated by a voicemail subscriber, such as devices 18, 20, and 22 described above in connection with FIG. 1. Likewise, user terminal 419 can be any connected device operated by a user, such as devices 18, 20, and 22 described above. One or more processors 108 (FIG. 2) operate the telephony server 440, web server 430, and voicemail server 410 according to the applications discussed previously.

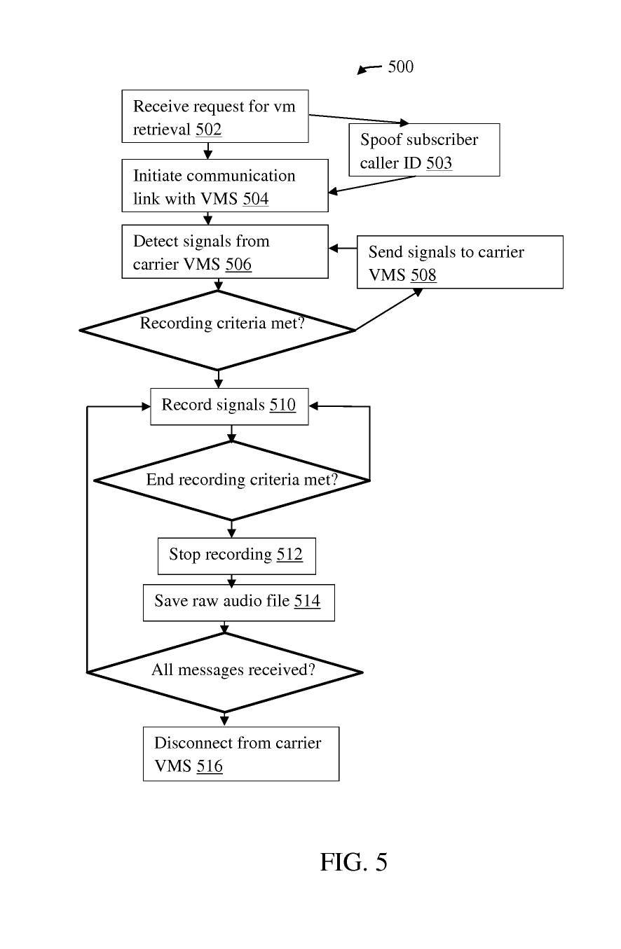

Operation of various methods according to the invention will now be described. FIG. 5 depicts one embodiment of a voicemail retrieval and processing method 500 according to the invention. Referring to FIGS. 2, 4 and 5, a subscriber terminal 18, 20, 22, 418 interacts with web interface application 130, native application 450 or web server 430 to send a signal 502 to processor 108 via network 12, 14, 16, 412, requesting that voicemail data be retrieved from a carrier VMS 24. Alternatively, the request to retrieve may originate from voicemail application 110, 410, MWIS 28, or other sources based on a voicemail being received, a predetermined time passing, or other criteria. Communications application 140/telephony server 440 instructs the processor 108 to access user data 104, 404 to cross-reference account/device data 156, carrier access numbers 154, and data input by the subscriber terminal 18, 20, 22, 418 to dial the specific carrier access number assigned to the subscriber 504.

The carrier access number 154 may be, for example, the subscriber's own mobile telephone number, a main voicemail access number, etc. The subscriber's own telephone number may be linked to a particular “backdoor,” “pilot” or “deposit” number in the carrier's VMS 24 when it is called from the subscriber's line. A backdoor/pilot/deposit number is a direct-dial number within the carrier's PBX system that provides more direct access to the subscriber's voicemails. Alternatively, carrier access number 154 may be the backdoor/pilot/deposit number, providing more direct access to the voicemail server for that particular subscriber. Many carriers have either one or multiple assigned voicemail systems in which lines connect as assigned by the carrier. These VMS's can be accessed by dialing to them via the backdoor/pilot/deposit number defined by the carrier or by “spoofing” the VMS. In some carrier systems, direct access via the backdoor/pilot/deposit numbers is automatically provided when the subscriber's number is dialed from the subscriber's number. In one embodiment, the processor 108 may call the subscriber's mobile telephone number, while “spoofing” the subscriber's mobile telephone number 503. “Spoofing” is the practice of sending caller ID information indicating a different calling number than the actual calling number. Various methods of spoofing are well-known in the art and therefore will not be described in this specification.

Communications application 140/telephony server 440 and/or voicemail application 110, 410 then instruct(s) processor 108 to detect signals received from carrier VMS 24, such as speech, silence, or the like 506, and send signals 508, for example touch tones, to carrier VMS 24. The signals may be sent 508 at a time based on predetermined conditions being met 507. Predetermined conditions may be, for example, a certain time length and/or depth of silence being detected indicating that the IVR is awaiting a response, a predetermined time transpiring from initiation of the call based on anticipated carrier WR scripts, certain words being detected by, for example, a speech recognition feature of the voicemail application, etc., or any combination.

The signals sent 508 may be based on user data 104, 404, such as, for example, touch tones corresponding to account numbers and passwords in account/device data 156 that are cross-referenced to the subscriber's account. The steps of sending 508 and receiving 506 signals to navigate the IVR in the carrier VMS 24 may be repeated as desired by the subscriber in order to fetch new data from the carrier VMS 24. Fetch can be scheduled to be done every 15 minutes, hourly, daily, weekly, or manually from, for example, a command sent from terminal 18, 20, 22, 418.

Processor 108 begins recording the signals 510 received from the call 506 based on a predetermined criteria, for example, an anticipated script from the IVR, a predetermined time passing, speech recognition of a key word or string such as “first new message”, change of voice frequency, etc. In one embodiment, the processor 108 begins recording of the signals 510 at the initiation of the call. The signals may correspond to header information, for example, time and date stamp or caller ID, audio from voice messages left, prompts from the carrier's VMS 24 IVR, etc.

Processor 108 then stops recording the signals 512 based on a predetermined criteria, for example, a threshold duration and/or level of silence, a sound detected, etc. The signals are then saved 514 as a raw audio file.

Processor 108 then again sends 508 and receives 506 signals to navigate the carrier's VMS 24 IVR system to play and record a second message, etc., until the processor 108 determines that all messages have been received. At that point, the processor 108 disconnects 516 the connection to carrier VMS 24.

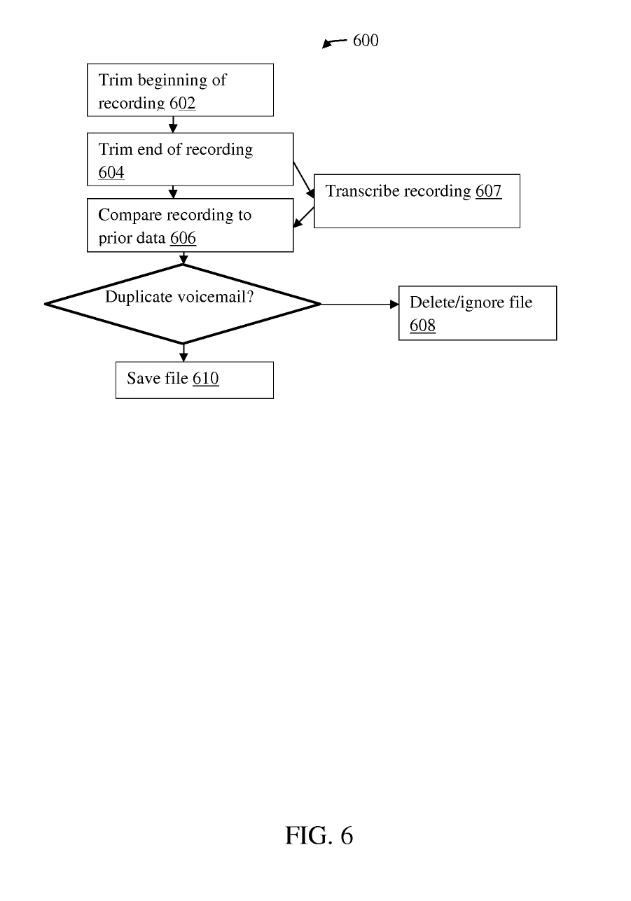

As shown in FIG. 6, one embodiment of a method of processing the raw audio files is depicted. The raw audio files are trimmed 602 by the processor 108 according to instructions from the voicemail application 110, 410 and/or communication application 140/telephony server 440. The amount of trimming can be based on various criteria, such as, for example, a predetermined amount of time passing, a period of time of detected silence at or below a certain level, speech recognition of a key term or string, the number of voicemail messages detected before the instant voicemail based on different anticipated IVR prompts, etc. The trailing sound at the end of the raw audio files are then trimmed 604 based on criteria, such as those described above. The trimmed audio files can then be compared 606 with previously saved messages 152 to determine whether they correspond to duplicate voicemails. Alternatively, determination of duplicate voicemail may be done prior to trimming 602 and 604. If they are determined to be duplicate, they can be deleted/disregarded 608. If not, the audio file can be saved 610 as user data 104, 404.

In one variation, the comparison 606 is done by transcribing the audio files via speech recognition 607 and comparing a transcription to previously transcribed messages or headers stored in the user data 104, 404. Speech recognition may be effected through known systems, such as, for example CMUSphinx™ or other available speech recognition applications capable of detecting and recognizing speech from signals.

Although the method of FIG. 6 was described as occurring after the call with the carrier's VMS 24, it can also occur during the call and based on either the raw audio file or the audio signals received. For example, a determination of whether the signal or raw audio file constitutes a duplicate may be one of the criteria determining whether the recording should be stopped 512, the signals should be saved 514, what signals should be sent 508 to the carrier's VMS 24 IVR, whether/where the raw audio files should be trimmed 602, 604 or transcribed 607. If the signals being recorded 510 correspond to header information, the comparison 606 may determine whether the processor 108 navigates the IVR to record the audio signals from the corresponding voicemail. The voicemail application 110, 410 may instead opt to bypass recording of any duplicate messages to save time and disk space.

Although FIGS. 5-6 described methods of obtaining voicemail messages from audio signals played by the carrier's VMS 24, it is also within the scope of the invention for voicemail messages to be received and recorded in the user data 110, 410 directly, allowing the voicemail server 100, 401 to act as its own VMS, similar to carrier VMS 24. In other embodiments of the invention, the voicemail messages are downloaded from files resident on user terminals 18, 20, 22, such as, for example, audio and header files stored on a subscriber's mobile telephone, laptop, tablet, etc.

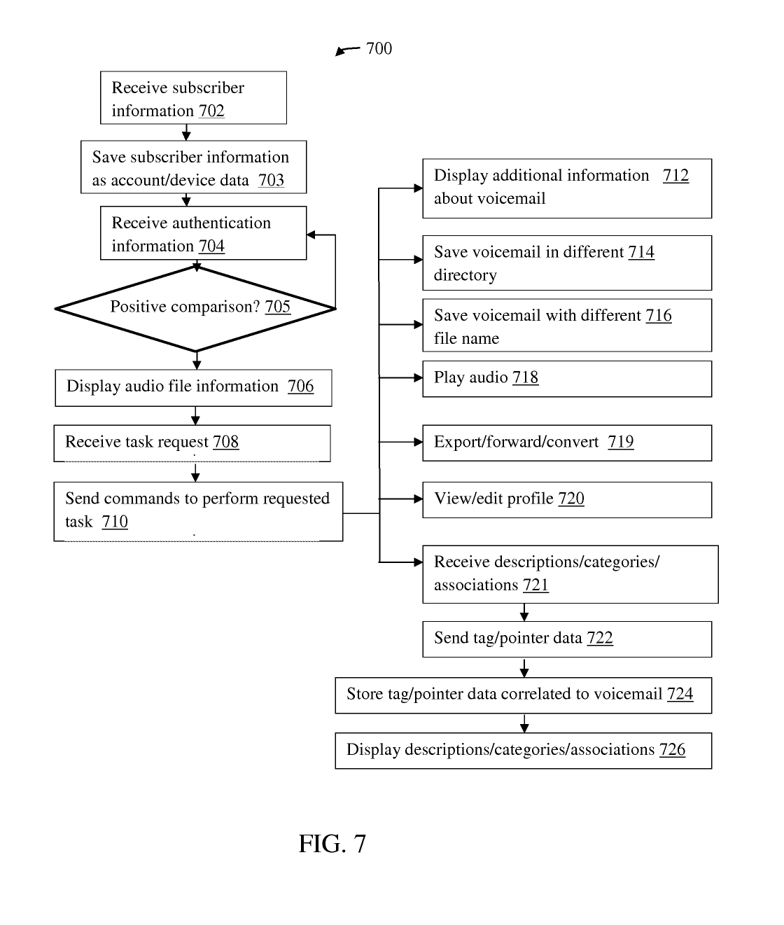

FIG. 7 depicts an embodiment 700 of a method for access and management of the messages stored in user data 104, 404. Messages may include, for example, stored voicemails, voice memos, etc. When a subscriber sets up an account, information relating to the subscriber and the voicemail account, such as account number, name, telephone number, password, birthday, family members, etc. is received 702 and saved 703 as account/device data 156 via web interface application 130/web server 430. Once the signals received on the call are stored in user data 110, 410, a subscriber can access the data 110, 410 via web interface application 130/web server 430 by, for example, providing authentication information 704 via subscriber terminal 18, 20, 22, 418. The entered authentication information is compared 705 to data stored as account/device data 156 of user data 104, 404.

If correct, information relating to the audio files, such as, for example transcribed headers of the voicemails, directory structure, file name, links for playing audio files, etc., can be displayed 706 on the subscriber terminal 18, 20, 22, 418. The subscriber can, for example, select 708 the information displayed and the processor 108 sends commands 710 via the network 12, 14, 16, 412 and the terminal 18, 20, 22 performs the requested task, e.g., display additional information about the voicemail 712, send commands to save the voicemail in a different directory 714 in the user data 104, 404, with a different file name 716, play the audio 718 from the message through the terminal's speakers faster, slower, rewind, fast forward, etc.; export, forward, or convert the message file to a separate format, device, user, website, email, social network (publically visible or via private link), etc. 719 through, for example a file transfer or through sending a link to the voicemail, etc. The subscriber may also request to view or edit their user profile 720 by editing data stored in the account/device data 156.

In one embodiment, a subscriber may indicate descriptions, categories, or associations related to the voicemail 721, such as “favorites,” “ex-girlfriends”, or “Anna”. This tag/pointer data can then be sent 722 via network 12, 14, 16, 412. The data can then be stored 724 according to instructions in the tag/edit/convert application 120 in the user data 104, 404 as tag/pointer data 158 and correlated to that voicemail. The descriptions, categories, or associations can thereafter be displayed 726 in connection with that particular voicemail or a number of similarly-described voicemails, which could be displayed as albums or directories. A voicemail may also be tagged with a picture. For example, a saved voicemail of a subscriber's wife announcing she is pregnant may later be tagged with a stored or uploaded photo of the newborn child. In one embodiment, the tag/edit/convert application 120 instructs the processor to store automatic tags for the voicemails. For example, all voicemails received on a user's birthday, as cross-referenced in the account/device data 156, may be accessed through a directory/album “birthday”. Likewise, all voicemails received from a user's family members, as cross-referenced in the account/device data 156, may be accessed through a directory/album “family,” and voicemails received from a user's family member on their birthday may be accessed through both the “family” and “birthday” directories/albums. Although the tags are discussed in terms of pointers, it is also within the scope of the invention for the messages to be saved in directory structures according to the description.

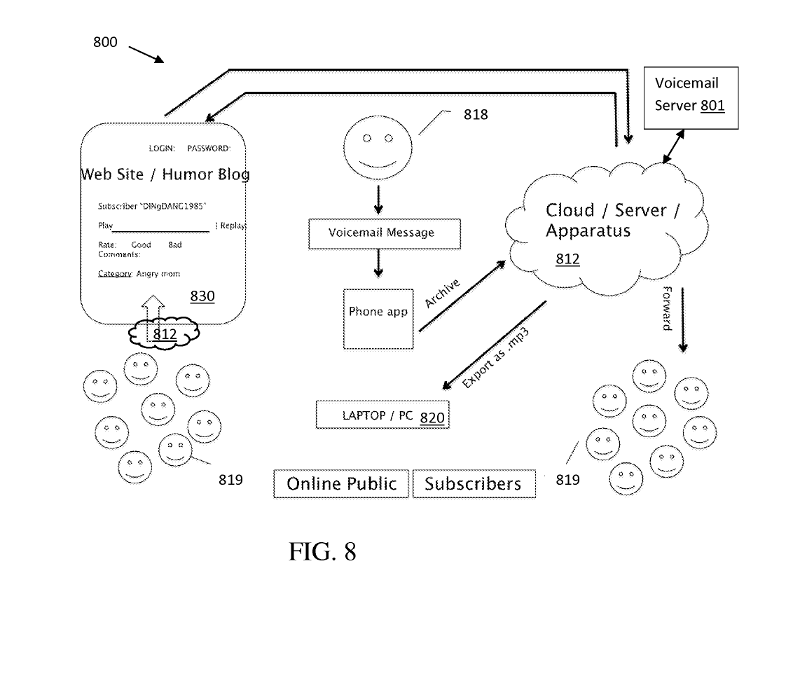

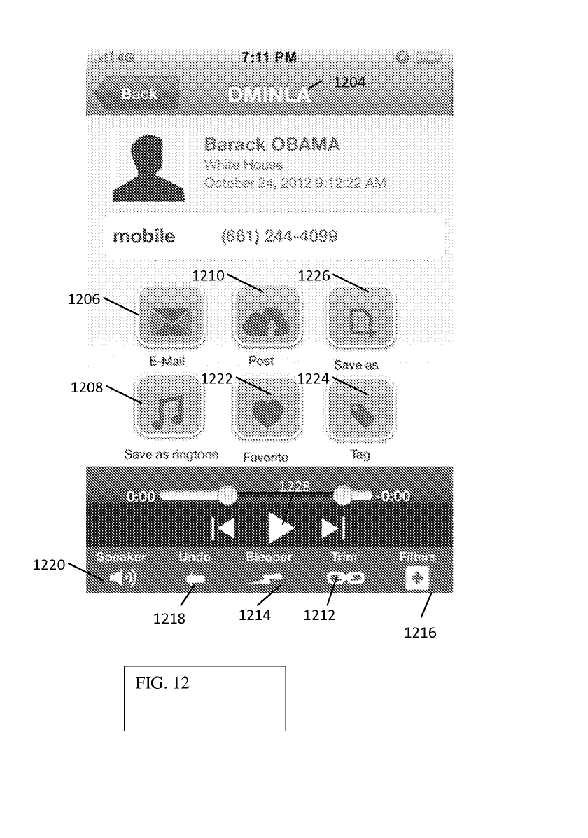

FIGS. 8 and 12 respectively show a simplified flow diagram of a voicemail sharing and managing system and method 800 according to the invention, and a display of a user interface according to one embodiment of the invention. A subscriber receives a voicemail on device 818, such as the subscriber terminals 18, 20, 22 described above. Through an application running on the device 818, the subscriber 1204 uploads the voicemail through network 812, similar to network 412, to voicemail server 801, similar to voicemail server 100 described above. If an “export” request is sent by the subscriber, the tag/edit/convert application 120 can then instruct the processor 108 to send the voicemail to a separate location, such as, for example, internet-connected device 820 or to other selected subscribers at user terminals 819, via an email 1206, ringtone 1208, post 1210, etc. buttons. The tag/edit/convert application 120 may also instruct the processor to cut out portions of the voicemail 1212, “bleep” out portions 1214, change the frequency of the voice 1216, undo 1218, change volume 1220, “favorite” 1222, tag 1224, or save the voicemail in a particular file or directory 1226 etc. User data 104 may also be altered for that voicemail to allow it to be accessed by specified users/subscribers at other terminals 819. For example, a subscriber 818 may indicate that only family members may have access to the particular voicemail.

The voicemail data stored on voicemail server 801 may also be transferred 1210, or a link to it may be sent, to a webserver hosting a web-site/humor blog 830 accessible via the network 812 to the online public at additional user terminals 819. The data may be transferred anonymously, with designated tags 1224 entered by the subscriber. The web server 830 may allow the online public to play the voicemail 1228, and/or categorize 1224, rate 1222, comment on, etc. the particular voicemail. That information can then be transferred back through network 812 to voicemail server 801 to be stored in the user data 104, 404 for correlated to that voicemail.

The web server 830 in one embodiment can also collect voicemails or voicemail links from multiple sources and/or categorize the voicemails under common tags and/or categories. It may also tally ratings, comments, etc., for various voicemails and display a list of, for example, the highest rated voicemails. It can also provide a search function by tag and/or category to allow the online public 819 to find, for example, voicemails tagged “horrible bosses” or “calling in sick”. A voicemail may “go viral” as it gains exposure. In one embodiment, for example, a “battle of the stars” could occur with celebrities, bands, singers, etc. sending competing vocal voicemails to each other, to be followed by and rated by fans. The web server 830, web interface application 130, or native application 450 may allow users to “follow” a particular subscriber, search the database for key terms and/or trends, list comments from multiple voicemails, display profile information from a particular subscriber, as well as allow seamless access to the subscriber's own saved voicemails 104, 404, directories/categories, and tags, as described above in relation to web interface application 130, web server 430, and native application 450.

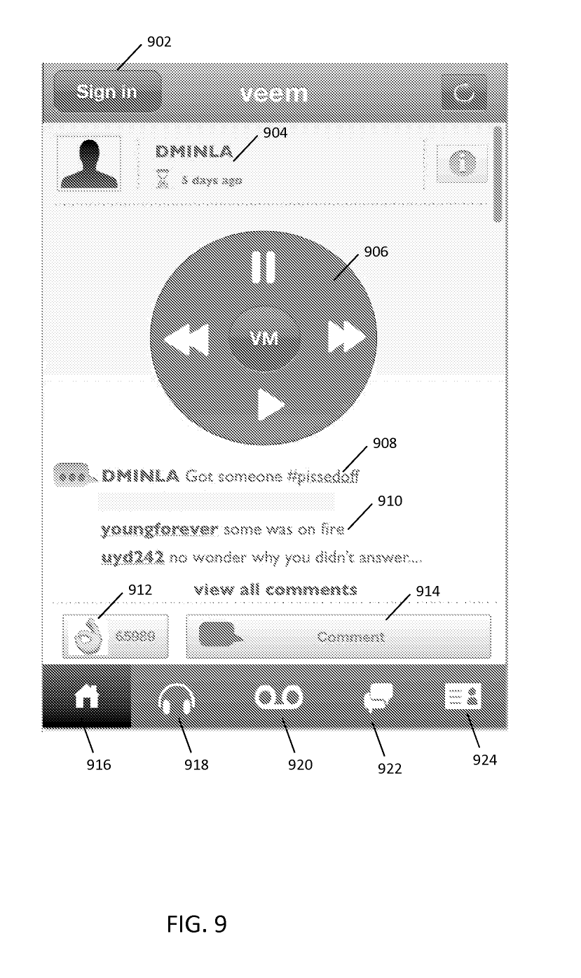

FIG. 9 depicts one example of a display 900 of the web site/humor blog 830 on a web server. A link to providing authentication information 902 is displayed, along with information regarding the subscriber who uploaded the voicemail 904, voicemail playback options 906, tags 908 provided by the subscriber who uploaded and/or other users, comments 910 from users, a tally 912 of users who rated the voicemail favorably, and an interface for commenting on the voicemail 914. Additionally, a user may have links to a home page 916, a search interface 918, the user's own voicemails 920, comments from users followed 922, and the user's profile 924.

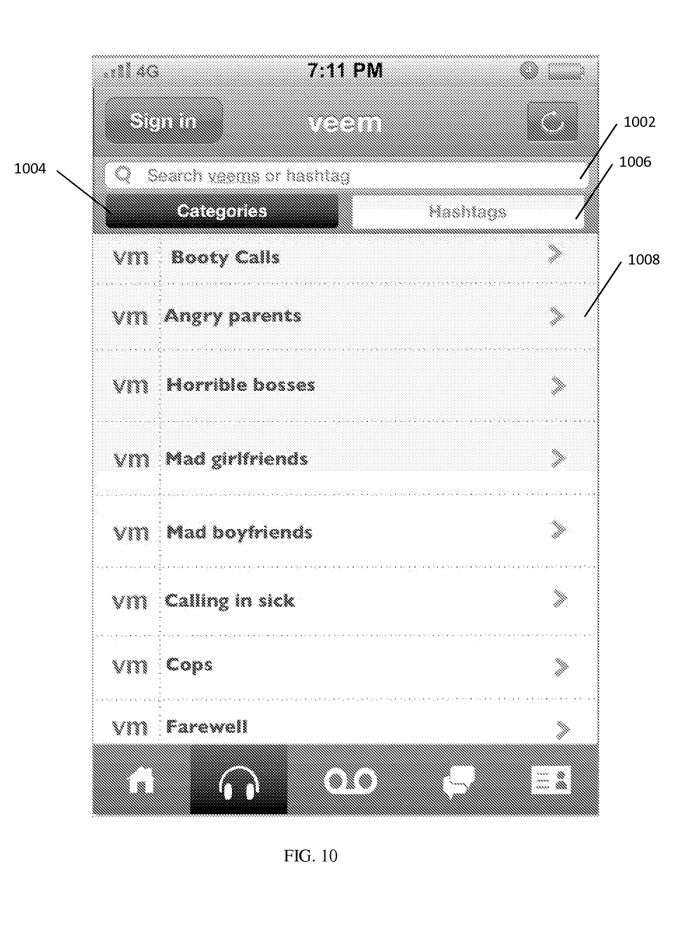

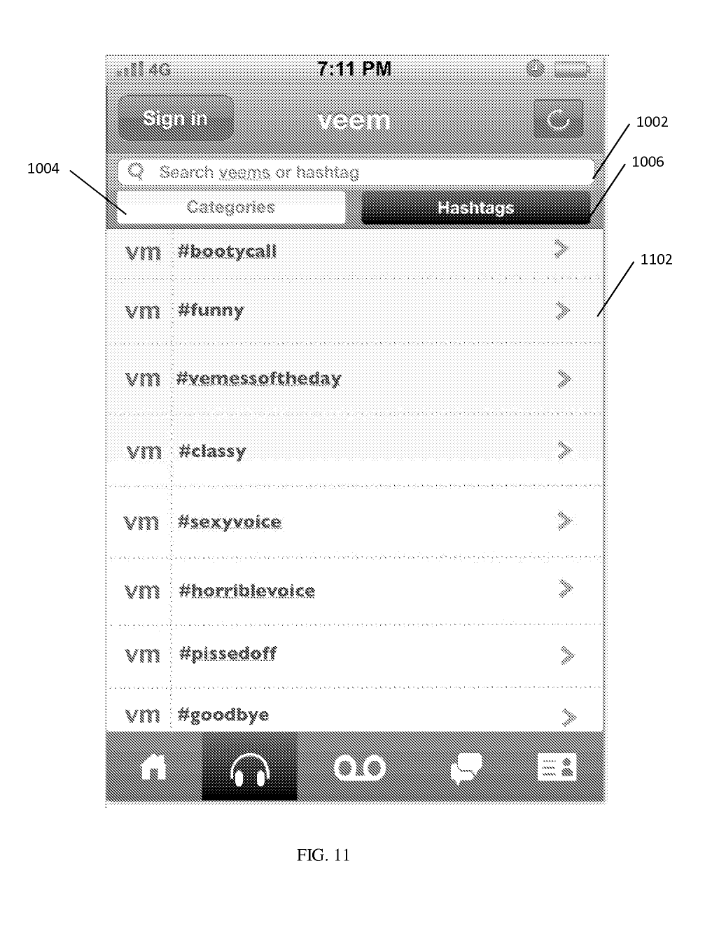

Referring now to FIG. 10, a search interface 918 is shown in more detail. A search field 1002 is displayed, where voicemails may be searched by category of hashtag. The category button 1004 displays a list of categories for voicemails, such as categories 1008. Hashtag button 1006 displays a list of hashtags 1102 (see FIG. 11).

Some advantages of systems as described herein are readily apparent, in that voicemails may be archived for an unlimited time, even if the voicemail service is provided by any carrier. Voicemails may effectively and efficiently managed and categorized, so that they can be found easily and grouped intuitively. Albums may be created and shared with, for example, descendants, as well as the general public.

The embodiments of the invention described herein are illustrative, rather than restrictive. Modification may be made without departing from the spirit of the invention as defined by the following claims and their equivalents.

What is claimed is:

1. A method of retrieving voicemail messages from a carrier in a communication network, the method comprising:
receiving a request to retrieve voicemail data from a carrier voicemail system;
connecting to the carrier voicemail system through the communication network;
receiving signals from an interactive voice response system of the carrier voicemail system;
sending signals to the carrier voicemail system to interact with the interactive voice response system based on response criteria;
upon detection of a playback criteria, recording audio received from the carrier voicemail system;
saving the recorded audio; and
disconnecting from the carrier voicemail system.
